(19) United States
(12) Patent Application Publication
(10) Pub. No.: US 2004/0248544 A1
(43) Pub. Date: Dec. 9, 2004

(54) Portable receiver with two antennae

(76) Inventor: Christian Lamothe, Neuchatel (CH)

Correspondence Address: SUGHRUE MION, PLLC, 2100 PENNSYLVANIA AVENUE, N.W., SUITE 800, WASHINGTON, DC, 20037, US

(21) Appl. No.: 10/485,864

(22) PCT Filed: Aug. 6, 2002
(86) PCT No.: PCT/EP02/08808

(30) Foreign Application Priority Data
Aug. 6, 2001 (EP) 01202999.7

(51) Int. Cl. H04B 1/06

(52) U.S. Cl. 455/404.1; 455/352

(57) ABSTRACT

The invention relates to a portable receiver comprising two antennae (10, 20) which are designed to receive an external electromagnetic signal in a given frequency range, and which are orientated along different axes. The receiver also comprises two phase shifter circuits (12, 22) each connected to an antenna, and multiplexing means (24) to which are connected in input said phase shifter circuits and in output a receiving unit receiving the external phase-shifted electromagnetic signal. Moreover there are provided, between at least one of the phase shifter circuits (12) and the antenna (10) connected to this circuit, correction means (Rcor, Ccor) which are a function of said phase shifter means, of said multiplexing means and of the antennae. The correction means are designed to provide, in output of the phase shifter circuits, first and second electrical signals substantially phase-shifted by an angle of π/2, one with respect to the other and substantially equal in amplitude.

The present invention relates to a portable receiver with two antennae used in particular in the sphere of security systems for automotive vehicles.

The portable receiver comprises two antennae which are designed to receive an external electromagnetic signal in a given frequency range and which are orientated along substantially orthogonal axes. The receiver also comprises two phase shifter circuits each connected to one antenna, and multiplexing means to which are connected said phase shifter circuits in input and a receiving unit in output receiving the external phase-shifted electromagnetic signal.

A portable receiver, such as defined in the preceding paragraph, is known from the document FR 2 792 129. This document describes a usable portable receiver, in particular in an anti-theft system for automotive vehicles. In this case, the receiver is incorporated in a support of the smart card, badge or key type, called subsequently “identifier”, carried by the owner of the vehicle or by an authorised person. The support can also comprise a transmitter which allows a dialogue of the transmission-reception type to be established between the vehicle provided with the anti-theft system, hereafter called “identification unit”, and the person provided with the identifier.

If the agreement protocol between the identification unit and the identifier is respected, an authorisation signal transmitted by the identification unit allows operations to be activated, such as for example locking/unlocking of the locks or even decoding of an engine immobilising system.

The problem which this document seeks to resolve is that posed by the homogeneity of the reception of the signals by an identifier placed in an electromagnetic field transmitted by the antenna of the transmitter-receiver of the identification unit. In other words, the signal received by the receiver of the identifier must have an amplitude which is as large and constant as possible, whatever the orientation of the identifier at a given distance from the identification unit.

The approach consisting in using a “turning field” whether at the transmission level, i.e. at the identification unit level, or whether at the reception level, i.e. at the identifier level, is amply described in the introduction of the document FR 2 792 129 which clearly illustrates the difficulties of such an approach.

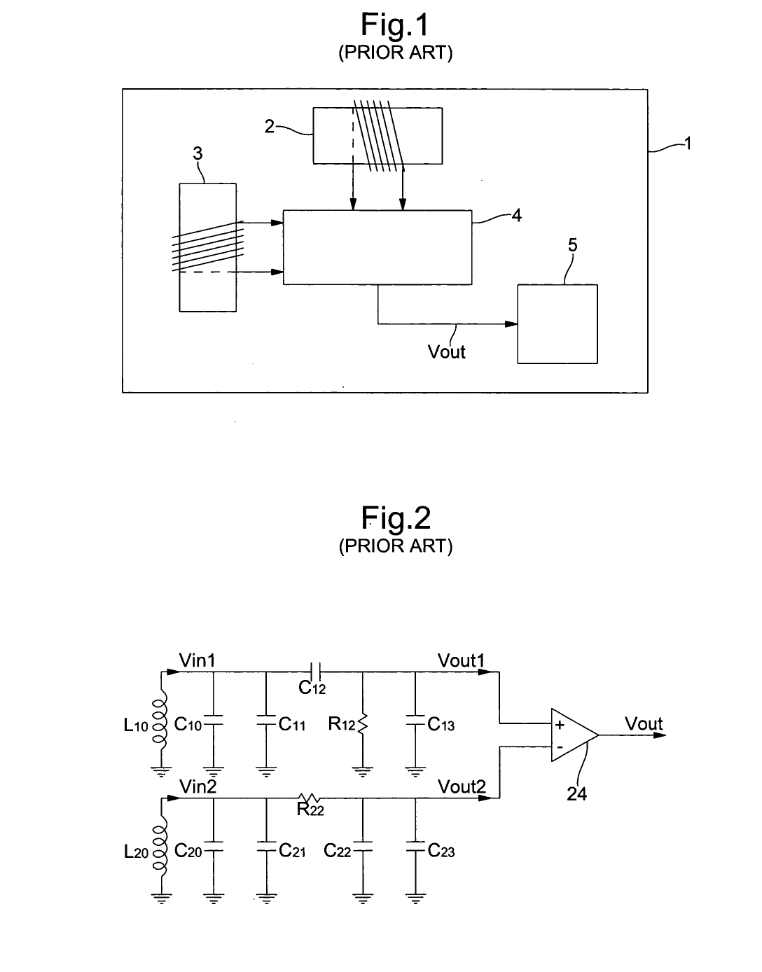

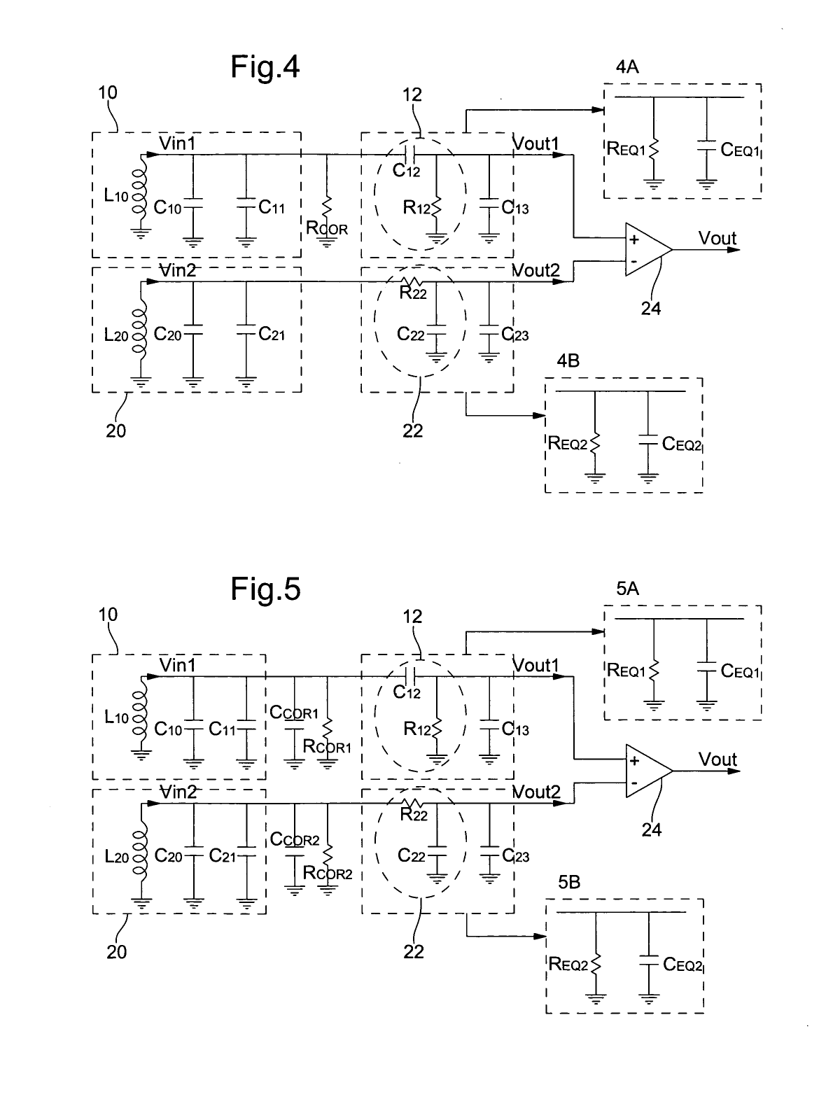

FIG. 1 represents a portable receiver 1 which is able to be incorporated in an identifier, such as for example a smart card, a key or a badge. The receiver 1 is provided with two antennae 2 and 3, each of the antennae being produced in the form of a coil which is preferably coiled on a ferrite core. The two antennae 2 and 3 are disposed perpendicularly, one with respect to the other. They are connected to an electrical circuit 4, allowing the signal delivered by the antennae to be phase-shifted. At the output of this circuit 4, a signal Vout is supplied to a receiving unit 5, generally formed by an adequately programmed integrated circuit. The circuit 4 will be detailed in the scope of prior art in FIG. 2, and within the scope of the invention in FIGS. 4, 5 and 7.

It should be noted that the portable receiver can also be equipped with a transmitting unit, not shown, allowing it to respond actively to the identification unit, for example an automotive vehicle.

The solution proposed by the above-mentioned document incorporates, between the receiving antennae and the receiving unit of the portable receiver, means for producing a temporal phase shift between the external signals received by said antennae, corresponding to the circuit 4 of FIG. 1.

This solution raises the obtainment of a phase shift corresponding to an angle of (n−1)*π/n with respect to the frequency of the signal to be received, n being the number of antennae. In the particular case where the receiver comprises two antennae, the phase shift is therefore 90°. For this, it is specified that each antenna is connected to a phase shifter circuit allowing phase-shifting respectively by +45° and −45° of the signals delivered by the antennae. The embodiment proposed for the two phase shifter circuits comprises an RC circuit and a CR circuit. The two circuits together according to this document should allow the desired phase shift of 90° to be obtained. The choice of such a phase shift is explained by the fact that the difference between the two signals phase-shifted by the RC and CR circuits never cancel each other out.

The main disadvantage of this solution comes from the fact that the production of the circuit as described does not allow the desired phase shift to be obtained and likewise does not ensure the sought stability in amplitude. In fact the proposed assembly takes account neither of the subtractor placed at the output of the phase shifter circuits nor the inherent characteristics of the antennae.

FIG. 2 is a representation of the above-mentioned solution including the stray elements, non-negligible, of the subtractor and of the antennae. The antennae are produced in the form of coils L10 and L20 having a stray capacitance represented respectively by the capacitors C10 and C20, to which there can be added tuning capacitors C11 and C21, the antennae being tuned to the frequency of the signal to be received. Each coil L10, L20 is connected to a phase shifter circuit, the coil L10 being connected to the CR circuit formed by the capacitor C12 and the resistance R12, and the coil L20 being connected to the RC circuit formed by the resistance R22 and the capacitor C22.

At the output of the phase shifter circuits, the capacitors C13 and C23 represent the stray capacitances of the inputs of the subtractor 24. The signals Vout1 and Vout2 recovered at the output of the two phase shifter circuits are subtracted in the subtractor 24 which delivers a Vout signal phase-shifted theoretically by 90° with respect to the input signals Vin1 and Vin2 delivered by the coils L10 and L20.

One of the causes of the malfunctioning of the circuit proposed by the document FR 2 792 129 comes from the fact that the stray capacitances C13 and C23, which are occasionally negligible are within the scope of this application of the same order of magnitude as the capacitances used in order to produce the phase shifter circuits CR and RC. Within the scope of the present invention it has been revealed that this is one of the reasons for which the phase shift of the two phase shifter circuits is not +45° and −45°, and that the phase shift of the two signals at the input of the subtractor 24, one with respect to the other, is not 90°.

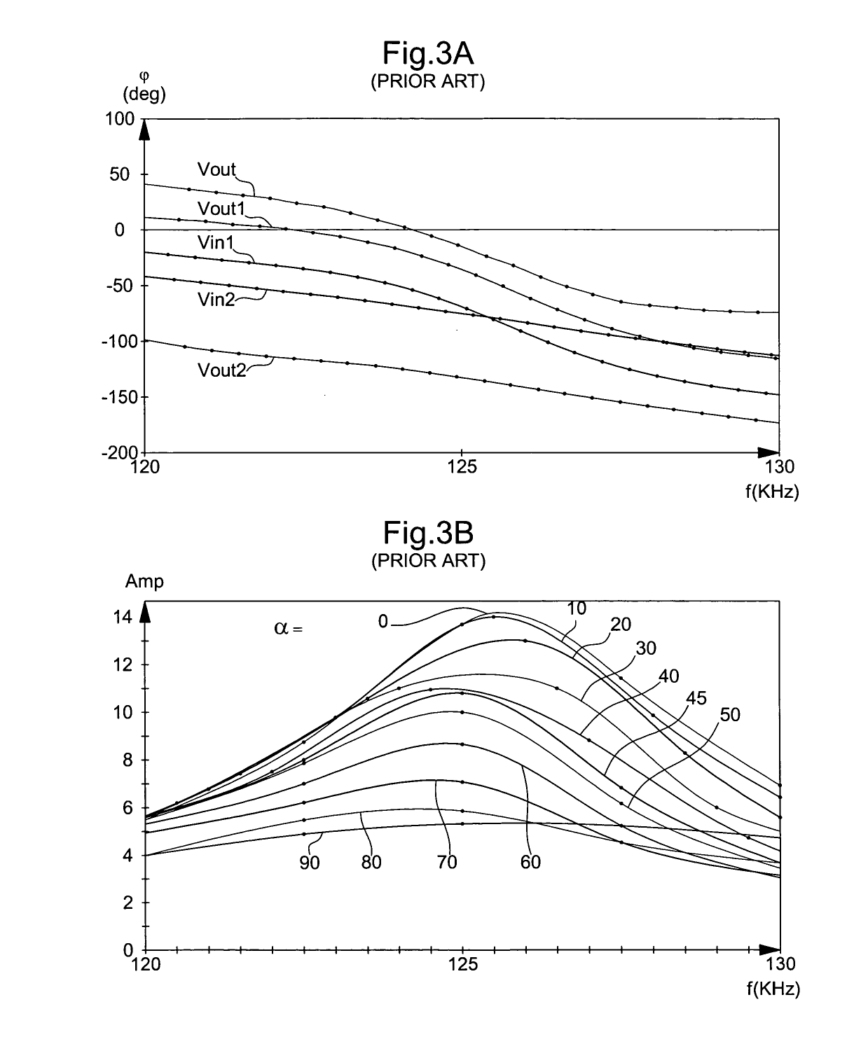

FIG. 3A is a simulation of the operation of the circuit according to prior art representing the development of the phase shift between the signals delivered at the output of the coils, Vin1 and Vin2, the signals Vout1 and Vout2 provided at the input of the subtractor and the signal Vout delivered at the output of the subtractor. The generally used frequency for this type of application is 125 KHz, this is why the simulation has been done in a frequency range from 120 to 130 KHz.

Initially, the antennae receive the same signal transmitted by the transmitting antenna of the identification unit. As the two antennae are chosen to be identical, it might be expected that signals Vin1 and Vin2 delivered at the output of the coils would be identical. However it is not thus, because the stray capacitances at the input of the subtractor have a non-negligible influence. Within the scope of the present invention it has been noticed that the stray capacitances introduce a dissymmetry between the equivalent circuits of the two phase shifter circuits. The result is that the desired phase shifts (+45° and −45°) at the output of the phase shifter circuits are not obtained, as well as the overall phase shift (90°) between the signals Vout1 and Vout2.

The phase shift error due to the stray elements likewise has an influence on the homogeneity of the amplitude of the Vout signal. FIG. 3B is a simulation of the operation according to prior art, representing the development of the amplitude of the output signal Vout as a function of the angle between the signal transmitted by the identification unit and the antennae of the identifier.

The chosen angles are selected with a step of 10° between 0° and 90°. It is noted that the amplitude of the output signal Vout varies greatly, according to the angle of reception of the signal transmitted by the identification unit. The amplitude variations, in the scope of this example, can exceed a factor of three.

It is important to recall that the objective of such a circuit is above all to obtain a Vout signal having an amplitude which is as constant as possible in order to ensure a constant reception quality whatever the position of the identifier with respect to the identification unit.

A solution which can be envisaged for the person skilled in the art would be to include the stray capacitance C23 in the determination of the capacitance C22 of the phase shifter circuit RC. In fact, as the values of the capacitances which are connected in parallel are added, it is sufficient to diminish the value of the capacitance C22 by the value of the stray capacitance C23. The disadvantage of such a solution comes from the fact that it is not applicable to the other phase shifter circuit CR. In fact it is not possible to include the stray capacitance C13 in the phase shifter circuit CR because it is the resistance R12 which is situated in parallel with the capacitance C13. The problem encountered in the document FR 2 792 129, i.e. lack of equilibrium between the equivalent circuits of each of the phase shifter circuits, would not be resolved. In fact this manner of proceeding, far from improving the operation of the receiver, makes it less viable than the former.

The solutions of prior art, in particular that of the document FR 2 792 129, do not take into account, or not in a correct manner, the stray elements of the overall circuit.

It is important to note that the solutions of prior art do not envisage the case where the antennae of the receiver would be different, a case which is included in the solution according to the invention.

The present invention therefore proposes to reduce the above-mentioned disadvantages by providing a portable receiver having a phase shift of 90° and a similar amplitude between the signals provided at the input of the multiplexing means in order to be able to provide an output signal having a substantially constant amplitude, whatever the angle of reception of the signal received by this portable receiver.

To this end, the portable receiver according to the invention, in addition to the fact that it satisfies the definition given in the introduction to the description, is characterised in that, between at least one of the phase shifter circuits and the antenna connected to this circuit, it comprises furthermore correction means which are a function of said phase shifter means, of said multiplexing means and of the antennae, these correction means being designed to provide, at the output of the phase shifter circuits, first and second electrical signals substantially phase-shifted by an angle of π/2, one with respect to the other and substantially equal in amplitude.

The circuit according to the invention operates in that it takes into account both the stray elements of the multiplexing means and the stray elements of the antenna. If one seeks to isolate the problems, those related to the output and those related to the input, the overall circuit seems to present no noteworthy malfunctioning. However, the overall circuit according to prior art does not operate in an effective manner. In fact it is the influence of the stray elements of the multiplexing means on the rest of the circuit and in particular on the control of the antenna which brings about the observed malfunctioning.

According to an advantageous embodiment of the invention, the correction means comprise a correction resistance taking into account the internal resistance of the antenna and the equivalent resistance of the phase shifter means and of the multiplexing means. The correction means can furthermore comprise a correction capacitor taking into account the internal capacitance of the antenna and the equivalent capacitance of the corresponding phase shifter circuit and of the multiplexing means.

In the present case comprising two antennae and where correction means are placed between each of the two antennae and the two phase shifter circuits, said two correction resistances are given according to the following formula Rcor=(Rant* Req)/(Req−Rant), where Rant is the internal resistance of the corresponding antenna, where Req is the equivalent resistance of the corresponding phase shifter circuit, Req being greater than or equal to Rant and the capacitances of the two correction capacitors are given by the following formula Ccor=Cant−Ceq, where Cant is the internal capacitance of the corresponding antenna and where Ceq is the equivalent capacitance of the corresponding phase shifter circuit and of the corresponding input of the multiplexing means, Cant being greater than or equal to Ceq.

Other features and advantages of the present invention will appear in the following description, given by way of non-limiting example and with reference to the appended drawings, in which:

FIG. 1, already described, is an overall representation of a portable receiver equipped with two antennae;

FIG. 2, already described, is an electrical circuit diagram of the phase shifter means used in a portable receiver, including the stray elements which are non-negligible, according to prior art;

FIG. 3A, already described, is a simulation of the operation of the circuit according to prior art representing the development of the phase shift between the various signals;

FIG. 3B, already described, is a simulation of the operation according to prior art, representing the development of the amplitude of the output signal as a function of the angle between the signal transmitted by the identification unit and the antennae of the identifier;

FIG. 4 is an electrical circuit diagram of the invention according to a first embodiment;

FIGS. 4A and 4B represent units equivalent to certain units of FIG. 4;

FIG. 5 is an electrical diagram of the invention according to a second embodiment;

FIGS. 5A and 5B represent units equivalent to certain units of FIG. 5;

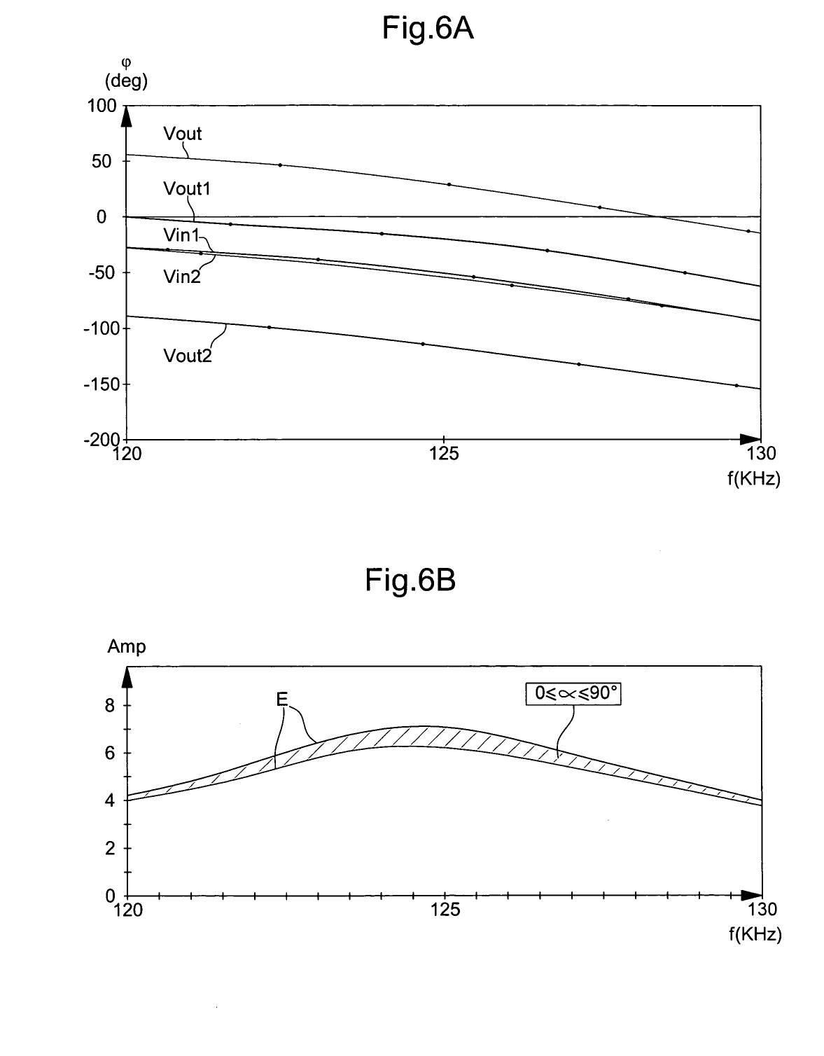

FIG. 6A is a simulation of the operation of the circuit according to the first embodiment of FIG. 4, representing the development of the phase shift between the various signals;

FIG. 6B is a simulation of the operation of the circuit according to the first embodiment of FIG. 4, representing the development of the amplitude of the output signal as a function of the angle between the signal transmitted by the identification unit and the antennae of the identifier;

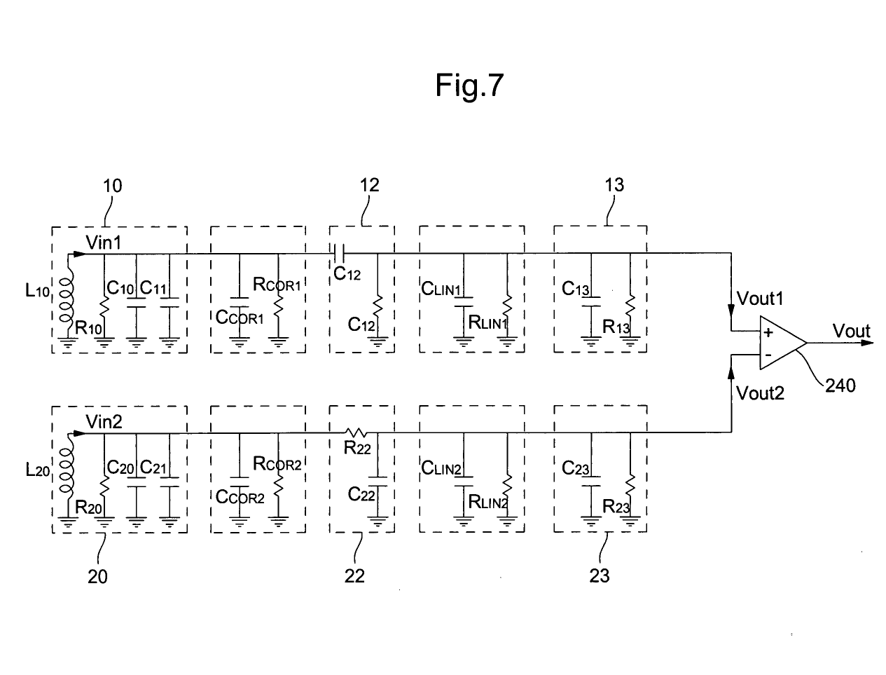

FIG. 7 is an electrical circuit diagram of the invention according to a third embodiment, including linearisation means of the multiplexing means.

FIG. 4 represents in detail the circuit 4 of FIG. 1, according to a first embodiment of the invention, in the case of a receiver provided with two identical antennae, correction means being placed between one antenna and a phase shifter circuit.

The two antennae 10 and 20 are represented respectively by a coil L10, an inherent capacitor C10 and a tuning capacitor C11, and by a coil L20, an inherent capacitor C20 and a tuning capacitor C21. Both antennae 10 and 12 receive an electromagnetic signal Vin, not represented, external to the portable receiver, transmitted by the identification unit. The coils L10 and L20 deliver in output the signals Vin1 and Vin2 respectively. These two signals Vin1 and Vin2 are respectively provided to a first phase shifter circuit 12 and to a second phase shifter circuit 22.

The first phase shifter circuit 12 is formed by a capacitor C12, a first armature of which is connected to the output of the antenna 10, and the second armature is connected to a first input of multiplexing means 24, for example a subtractor, and by a resistance R12 connected between the second armature of the capacitor C12 and the ground.

The second phase shifter circuit 22 is formed by a resistance R22 connected between the output of the antenna 20 and a second input of the subtractor 24, and by a capacitor C22, a first armature of which is connected to the second input of the subtractor 24, the second armature being connected to the ground. The elements of both phase shifter circuits are chosen in order to obtain the desired phase shift at the receiving frequency, for example 125 KHz.

The two phase shifter circuits 12 and 22 provide in output, to the first and second inputs of the subtractor 24, the signals Vout1 and Vout2 which are phase-shifted with respect to the signals Vin1 and Vin2 received at the input of said phase shifter circuits. The subtractor 24 not being an ideal element, it is necessary to include at each of its inputs a stray capacitor designated respectively C13 and C23. At the output, the subtractor 24 delivers a signal Vout=Vout1−Vout2.

It should be noted that the subtractor 24 placed at the output can be replaced by an adder.

One of the objects of the invention is to produce a circuit allowing an output signal Vout to be obtained, having a substantially constant amplitude. For this, it is necessary that the signals Vout1 and Vout2 are phase-shifted by 90° and with an equal amplitude.

The amplitude and the phase of these signals are determinable by the calculation of the transfer function (Vout1/Vin1 and Vout2/Vin2) of each of the sub-circuits containing the phase shifter circuits. In order to calculate these two transfer functions, each phase shifter circuit associated with the stray capacitance of the subtractor is transformed in an equivalent parallel RC circuit, as represented in FIGS. 4A and 4B.

The phase shifter circuit 12 and the capacitor C13 can be replaced by an equivalent circuit formed by an equivalent resistance Req1 and by an equivalent capacitor Ceq1 in parallel, as represented in FIG. 4A.

The phase shifter circuit 22 and the capacitor C23 can be replaced by an equivalent circuit formed by an equivalent resistance Req2 and by an equivalent capacitor Ceq2 in parallel, as represented in FIG. 4B.

It appears therefore that the equivalent resistances Req1 and Req2 are clearly different, and that the capacitances of the equivalent capacitors Ceq1 and Ceq2 are also different.

The lack of equilibrium between the equivalent resistances Req1 and Req2 is prejudicial at the level of the amplitude and of the phase shift of the output signal. In fact, the amplitude of the output signals Vout1 and Vout2 is given by the module of the transfer functions (Vout1/Vin1 and Vout2/Vin2) which depends upon the corresponding equivalent resistance (Req1 and Req2). Likewise, the phase shift between the output signals Vout1 and Vout2 and the input signals respectively Vin1 and Vin2 is given by the argument of the transfer functions which depends upon the corresponding equivalent resistance (Req1 and Req2).

This is why it is necessary to correct the two antennae as a function of the respective equivalent circuit, or one of the two antennae as a function of the two equivalent circuits.

In order to correct the two antennae, or one with respect to the other, correction means are provided between at least one antenna and the corresponding phase shifter circuit. These correction means are formed, according to this first embodiment, by a correction resistance Rcor connected between the output of the antenna 10 and the ground. This correction resistance Rcor has the objective of balancing the equivalent resistances Req1 and Req2.

It is important to note that one of the transfer functions is real and the other is imaginary. Thus, once the two transfer functions are balanced by the determination of the correction resistance Rcor, there is a constant phase shift of 90° between the two signals Vout1 and Vout2, and a constant amplitude of the signals Vout1 and Vout2 no longer depending upon the angle of reception of the received signal. Hence, the output signal Vout is phase-shifted by 90° with respect to the input signals Vin1 and Vin2, with a constant amplitude whatever the angle of reception.

According to a not shown variant of this first embodiment, the correction means comprise furthermore a correction capacitor Ccor allowing the equivalent capacitances Ceq1 and Ceq2 to be balanced.

FIG. 5 is an electrical circuit diagram of the invention according to a second embodiment. The numerical references used in FIG. 4 have been retained for the corresponding elements of FIG. 5.

According to this second embodiment of the invention, the correction means comprise preferably a correction resistance and a correction capacitor in order to correct each antenna.

The correction means (Rcor1 and Ccor1) placed at the output of the first antenna 10 are formed by a correction resistance Rcor1 connected between the output of the antenna 10 and the ground and by a correction capacitor Ccor1 connected in parallel with the correction resistance Rcor1.

The correction means (Rcor2 and Ccor2) placed at the output of the second antenna 20 are formed by a correction resistance Rcor2 connected between the output of the antenna 20 and the ground and by a correction capacitor Ccor2 connected in parallel with the correction resistance Rcor2.

The correction resistances Rcor1 and Rcor2 have the objective of balancing the equivalent resistances Req1 and Req2. The correction capacitors Ccor1 and Ccor2 have the objective of balancing the capacitances Ceq1 and Ceq2.

These correction elements are given by the following formulae:

Rcor=(Req×Rant)/Req−Rant)

where Rant is the tuning resistance of the corresponding antenna, and Req is the equivalent resistance of the corresponding phase shifter circuit and of the multiplexing means, Req being greater than or equal to Rant;

Ccor=Cant−Ceq

where Cant is the tuning capacitance of the corresponding antenna and where Ceq is the equivalent capacitance of the corresponding phase shifter circuit and of the multiplexing means, Cant being greater than or equal to Ceq.

It is also important to note that the portable receiver according to the invention advantageously allows the use of two antennae having different inherent characteristics. In fact, the determination of the values of the correction elements depends also upon inherent characteristics of the antennae, it is therefore easy to modify these correction elements in order to obtain an amplitude and a constant phase shift.

FIG. 6A is a simulation of the operation of the circuit according to the first embodiment of FIG. 4, representing the development of the phase shift between the signals delivered at the output of the antennae Vin1 and Vin2, the signals provided at the input of the multiplexing means Vout1, Vout2 and the output signal Vout.

The two phase shifter circuits are corrected by the addition of the correction resistance. Both antennae being chosen to be identical in this example, they deliver in output the signals Vin1 and Vin2 perfectly in phase and of equal amplitude. The signals Vout1 and Vout2 represent the signals delivered at the output of the phase shifter circuits. Each phase shifter circuit effects a phase shift of approximately +45° or −45°, according to the precision in the determination of the values of the correction elements. But as has already been emphasised, the transfer functions being real for one of the sub-circuits and imaginary for the other, the relative phase shift between the two phase shifter circuits is constantly 90° over the desired frequency range, 120 to 130 KHz in this example. The signal Vout delivered at the output of the multiplexing means, here a subtractor, corresponds to the difference Vout1−Vout2, between the signals delivered at the output of the phase shifter circuits, the phase shift of the signal Vout with respect to the input signals Vin1 and Vin2 being 90°.

FIG. 6B is a simulation of the operation of the circuit according to the first embodiment of FIG. 4, representing the development of the amplitude of the output signal as a function of the angle between the signal transmitted by the identification unit and the antennae of the identifier.

As is clearly visible, whatever the angle between the signal transmitted by the identification unit and the antennae of the identifier, the amplitude of the output signal Vout is included in the envelope E and is therefore substantially constant.

FIG. 7 is an electrical circuit diagram of the invention according to a third embodiment, including linearisation means of the multiplexing means.

The represented circuit comprises elements already present in the second embodiment of FIG. 5, to which certain stray elements considered as negligible in the first and second embodiments have been added and also linearisation means of the multiplexing means.

The portable receiver comprises, as in FIG. 5, two antennae 10 and 20, being able to have different inherent characteristics. Each antenna 10 and 20 is represented by a coil, respectively L10 and L20, an inherent resistance, respectively R10 and R20, an inherent capacitor, respectively C10 and C2, and a tuning capacitor, respectively C11 and C21. Within the scope of this application the inherent resistances R10 and R20 are negligible.

In parallel with the two antennae, the correction means already explained in FIG. 5 are found. These correction means are formed each by a correction resistance Rcor1 and Rcor2 and by a correction capacitor Ccor1 and Ccor2.

The phase shifter circuits CR and RC respectively 12 and 22 are formed by the resistances R12 and R22 and by the capacitors C12 and C22.

In output, the multiplexing means are represented by a subtractor 24, to which it is appropriate to add the stray elements 13 and 23 present at each of its inputs. The stray elements 13 and 23 are formed at each input of the subtractor by a stray capacitor C13 and C23 and by a stray resistance R13 and R23. Within the scope of this application, the stray resistances R13 and R23 are negligible. In contrast, the stray capacitances C13 and C23 are of the same order of magnitude as those used in the phase shifter circuits 12 and 22.

In order to linearise the variations of the values of these stray elements 13 and 23 as a function in particular of the variations in frequency of the signal to be received, linearisation means are added at each input of the subtractor 24, in parallel with stray elements 13 and 23. Preferably, one will use, as for the correction means of the antennae, a linearisation resistance R1in1 and R1in2 and a linearisation capacitor C1in1 and C1in2.

It is clearly understood that the description is given only by way of example and that other embodiments, in particular correction means, can be provided by the person skilled in the art.

1.-13. (canceled).

14. Portable receiver, comprising two antennae (10, 20) designed to receive an external electromagnetic signal in a given frequency range and orientated along different axes, two phase shifter circuits (12, 22) being each connected to one antenna, and multiplexing means (24) to which are connected in input said phase shifter circuits and in output a receiving unit, characterised in that, between at least one of said phase shifter circuits and the antenna connected to this circuit, this receiver also comprises correction means (Rcor, Ccor) allowing the transfer functions (Vout1/Vin1 and Vout2/Vin2) of each of the sub-circuits comprising the phase shifter circuits to be balanced.

15. Portable receiver according to claim 14, characterised in that each phase shifter circuit associated with the stray capacitance (C13, C23) of the multiplexing means is assimilated in an equivalent circuit comprising an equivalent resistance (Req1, Req2) and an equivalent capacitance (Ceq1, Ceq2) in parallel, said correction means comprising a correction resistance (Rcor) allowing said equivalent resistances of said equivalent circuits to be balanced.

16. Portable receiver according to claim 15, characterised in that the correction means comprise furthermore a correction capacitor (Ccor) allowing said equivalent capacitances of said equivalent circuits to be balanced.

17. Portable receiver according to claim 14, characterised in that said first and second phase shifter circuits are provided with correction means, and in that said correction means of the first phase shifter circuit comprise a first correction resistance (Rcor1) connected between the output of the antenna connected to said first phase shifter circuit and the ground, and in that said correction means of the second phase shifter circuit comprise a second correction resistance (Rcor2) connected between the output of the antenna connected to said second phase shifter circuit and the ground, said first and second correction resistances being given by the formula Rcor=(Rant*Req)/(Req−Rant), where Rant is the tuning resistance of the corresponding antenna and Req is the equivalent resistance of the corresponding phase shifter circuit and of the multiplexing means, Req being greater than or equal to Rant.

18. Portable receiver according to claim 17, characterised in that said correction means of said first and second phase shifter circuits comprise furthermore respectively, in parallel with said first and second correction resistance, first (Ccor1) and second (Ccor2) correction capacitors having a respective capacitance, said capacitances of the correction capacitors being given by the following formula Ccor=Cant−Ceq, where Cant is the tuning capacity of the corresponding antenna and Ceq is the equivalent capacitance of the corresponding phase shifter circuit and of the multiplexing means, Cant being greater than or equal to Ceq.

19. Portable receiver according to claim 14, characterised in that it comprises furthermore linearisation means (R1in1, R1in2, C1in1 and C1in2) of the multiplexing means.

20. Portable electronic device forming part of an anti-theft system for automotive vehicles, characterised in that it comprises a receiver according to claim 14.
